(19) United States
(12) Patent Application Publication
(10) Pub. No.: US 2008/0193740 A1
(43) Pub. Date: Aug. 14, 2008

(54) Composite building material and method for making composite building material

(76) Inventor: Jeffrey E. Nesbitt, Lititz, PA (US)

Correspondence Address: KENYON & KENYON LLP, ONE BROADWAY, NEW YORK, NY, 10004, US

(21) Appl. No.: 12/012,126

(22) Filed: Jan. 30, 2008

Related U.S. Application Data
(60) Provisional application No. 60/887,392, filed on Jan. 31, 2007.
(60) Provisional application No. 60/934,860, filed on Jun. 15, 2007.

(51) Int. Cl. B32B 9/04; B05D 3/02; C08F 2/48

(52) U.S. Cl. 428/318.4; 427/384; 427/508

(57) ABSTRACT

A composite building material and a method for its manufacture are provided. The method comprises the steps of: providing a foamable mixture comprising a polymeric matrix material, a filler, a processing aid, one or more lubricants, a thermal stabilizer, and a blowing agent; foaming said foamable mixture to form a foamed composite substrate; optionally embossing the substrate; and coating the substrate with a polyurethane/acrylic coating to form the composite building material, wherein the polyurethane/acrylic coating is keyed chemically and/or physically to the foamed composite substrate.

### CROSS REFERENCE TO RELATED APPLICATIONS

This application claims priority to U.S. Provisional Application Nos. 60/887,392, filed on Jan. 31, 2007, entitled COMPOSITE DECKING AND METHOD FOR MAKING COMPOSITE DECKING and 60/934,860, filed on Jun. 15, 2007, entitled COMPOSITE BUILDING MATERIAL AND METHOD FOR MAKING COMPOSITE BUILDING MATERIAL, the entire contents of each of which are hereby incorporated by reference herein.

### FIELD OF THE INVENTION

The present invention is directed to building materials and methods for making building materials. More specifically, the present invention is directed to foamed composite building materials that are substantially free of cellulosic material. Also, the present invention is directed to foamed composite building materials that are coated with a high performance urethane/acrylic coating.

### BACKGROUND OF THE INVENTION

Conventional building products, particularly for use in siding, trim, railing, decking and fencing, have included natural wood. Natural wood has been used traditionally for its availability and relatively low cost. However, drawbacks to natural wood exist. For example, the quality of available natural wood has diminished over time. Natural wood requires chemical treatment to extend service life in most exterior applications. Some treatment processes have been deemed environmentally unsound and have been prohibited in some jurisdictions, further diminishing the use of natural wood. In addition, natural wood has the drawback that it splinters, rots, discolors and/or requires significant maintenance when used in applications exposed to the outdoors.

Composite materials have been used as an alternative to natural wood because they are generally weather resistant and relatively maintenance free. Composite materials also have the ability to provide a wood-like appearance and texture. Composite materials are materials that have reinforcing material, typically fibers, embedded in a matrix material, typically a polymeric material. Polymeric materials known in the art include high or low-density olefin thermoplastic or a vinyl-based thermoplastic polymer. The particular polymer used in the composite depends on the properties desired in the final product. Typical fibers for use in building materials may be synthetic or natural fibers. The reinforcing fibers provide the final product with desired and improved properties, such as reduced thermal coefficient of expansion, strength and/or lower cost.

Composite materials are typically formed by extrusion. In this method, composite materials are formed by melting and extruding a matrix material. Typically, the matrix material is a polymeric material. In the extrusion method, an extruder melts the matrix material, while mixing the matrix material with the reinforcing fiber. The polymer becomes impregnated with the reinforcing fibers. In addition to the reinforcing fibers, additives may be introduced into the mixture. Suitable additives include stabilizers, antioxidants, UV absorbers, fillers and extenders, pigments, process aids and lubricants, impact modifiers, bactericides and other materials that enhance physical and/or chemical properties, as well as processing. A blowing agent or gas may also be introduced into the mixture. While the mixture is heated inside the extruder, the blowing agent thermally decomposes, releasing a gas, such as nitrogen or carbon dioxide, throughout the melted matrix material. After the matrix material, fiber and other additives are mixed, the melted mixture exits the extruder through a die. The mixture exits the die at a relatively high pressure. Once the mixture exits the die, the pressure exerted on the mixture is reduced to atmospheric pressure. The gases produced by the blowing agent expand under the reduced pressure and the matrix material solidifies, trapping the gas bubbles inside the composite material. The gas bubbles form voids in the composite, providing desirable properties to the final product. For example, the voids reduce the overall density and weight of the finished product. This process, called foaming, is becoming commonplace due to its cost advantage, as well as providing a weight-to-volume advantage. Although, most composites are still produced without blowing agent, the melt process is substantially the same.

One type of composite building material known in the art is a cellulose fiber reinforced cement composite disclosed in U.S. Pat. No. 6,777,103 to Merkley et al. (the '103 patent). This concrete-based composite material is being used on sidewalls, trim and roofing applications. Although the cement composite material is resistant to permanent water and termite damage when it is properly coated and installed, the cement composite suffers from several drawbacks. One disadvantage of the cement composite of the '103 patent is that the material is susceptible to cracking and chipping during transit, warehousing, job site storage, handling and installation. Another undesirable characteristic of the cement composite is that exterior products formed from the cement composite are subject to degradation of mechanical properties in geographic regions that experience freezing and thawing conditions. Another objectionable feature of the cement composite is that the density of the material is high, leading to heavy building components susceptible to sagging and/or breaking. The product is unforgiving of improper installation, and without proper sealing and drainage, it can be eroded by moisture penetration.

Another type of composite building material known in the art is a recycled wood and polyethylene composite disclosed in U.S. Pat. No. 6,527,532 to Muller et al. (the '532 patent). The material disclosed by the '532 patent is a wood-thermoplastic composite material generally having 35-60 wt % polyethylene matrix incorporating 65-40 wt % wood component. The wood component may be introduced in chip, fiber or flour form. The wood-thermoplastic composite, as disclosed in the '532 patent, has several drawbacks. One disadvantage is that the final product has a high density, increasing the shipping and handling demands. A further objectionable feature is a tendency to sag when used as a semi-load bearing material as in seating or decking. Additionally, the pigments and cellulosic additives in the wood-thermoplastic composite material, as disclosed in the '532 patent, run and/or fade when exposed to outdoor conditions. The wood fiber itself is prone to color shift when exposed to ordinary weathering forces, usually shifting to a weathered grey appearance. Another undesirable feature is that the wood-thermoplastic composite material, as disclosed in the '532 patent, absorbs and retains significantly high heat levels when exposed to sunlight due to the excessive absorption of infrared light. Another undesirable feature of the wood-thermoplastic composite material is that the cellulosic components therein contain nutrients that can support the growth of mold and/or mildew. Low stain, scratch and mar resistance are also undesirable features of these compositions.

Another type of composite building material known in the art is a foamed polymer-fiber composite disclosed, for example, in U.S. Pat. No. 6,344,268 to Stucky et al. (the '268 patent). The material disclosed by the '268 patent is a foamed polymer material reinforced with wood fibers. The composites include about 35-75 wt % polymeric resin and about 25-65 wt % fiber. The specific gravity of the material is less than about 1.25 g/cc and the coefficient of expansion is about 2.4×10⁻⁵/in/in/° F. The polymer-fiber composite has several drawbacks. The polymer-fiber composite disclosed in the '268 patent has essentially the same undesirable characteristics of the above composite disclosed by the '532 patent, although it is more fire resistant and somewhat more stable to sunlight. Another disadvantage of the polymer-fiber composite disclosed in the '268 patent is that the material experiences relatively rapid degradation of mechanical properties when exposed to outdoor conditions.

Exterior building products are exposed to the full solar radiation spectrum of light including damaging UV and IR wave lengths and to cycles of heating and cooling upon exposure to the sun. UV and heat sensitive substrates such as vinyl, polyolefins, styrenics (including ABS, ASA), polycarbonates, polyesters and other material are susceptible to UV light and heat degradation over long periods of time. Thus, methods for absorption of ultraviolet energy, transmission, absorption and reflectance of various frequencies of visible light (pigmentary color) and as much reflection of near infrared energy may be required.

It is therefore desirable to develop a composite building material, and a method for making a composite building material, that overcomes the disadvantages of the prior art.

### SUMMARY OF THE INVENTION

The present invention provides a process for preparing a foamed (cellular) composite building product comprising the steps of: providing a foamable mixture comprising a polymeric matrix material, a filler, a processing aid, one or more lubricants, a thermal stabilizer, and a blowing agent; extruding the molten foamable mixture; foaming said foamable mixture to form a foamed composite substrate; optionally embossing the substrate; and coating the substrate with a polyurethane/acrylic coating to form the composite building product, wherein the polyurethane/acrylic coating is chemically or physically bound (or “keyed”) to the foamed composite substrate.

The present invention includes as an embodiment, a method for making a composite building material involving the step of providing a matrix material precursor, a reinforcing filler material, a blowing agent, a stabilizer, one or more processing aids, and, optionally, other additives. The matrix material precursor, the reinforcing filler material, the stabilizer and process aid(s) are mixed to form an extrusion dry blend compound. The matrix material precursor typically comprises poly (vinyl chloride) resin. The reinforcing filler is preferably a nanoparticle sized calcium carbonate material that is surface treated with a polar compatibilizer. The blowing agent comprises a material that thermally decomposes and releases gas. The stabilizer comprises a metal ligand and is used to prevent degradation of the polymer under the high temperature of processing and to prevent further degradation at the slightly elevated service temperatures found in the outdoor environment. The extrusion mixture is heated to a temperature sufficient to volatilize any moisture or other volatile materials and then is heated to a melt temperature. This is all accomplished in a tightly controlled extruder. The melted composition is expressed at high pressure through a die to produce an extruded product and is sized and cooled at a controlled rate.

In one embodiment, the method and product according to the present invention produces a lightweight substrate product having the preferred physical and chemical properties. However, it is particularly preferred that the substrate be coated with a urethane/acrylic coating, particularly for applications in which the composite building material is used outdoors. Thus, in preferred embodiments of the present invention the method for producing the composite building material involves the step(s) of coating the substrate with a urethane/acrylic coating. In certain embodiments, the coating of the substrate with a urethane/acrylic coating is performed in-line as a part of the fabrication of the composite building material, rather than as a remote or separate step. In preferred embodiments of the invention the urethane/acrylic coating comprises one or more pigments and is cured using a UV curing step.

In particularly preferred embodiments, the urethane/acrylic coating may be coated onto the substrate and cured using an ultraviolet radiation curing system. The UV curing of the coating is initiated by a photoinitiator that absorbs distinct energies of UV light. The preferred coatings also contain IR reflective pigments and, optionally, one or more UV protective agents. The UV protection agents, IR-reflective pigments, and other optional coating components may absorb or reflect frequencies of UV radiation. Thus, in the past, the use of such coating components in conjunction with a UV curing systems would have been problematic, resulting in incomplete curing or low adhesion to the substrate. However, in the preferred coating compositions of the present invention, these problems have been overcome by the selection of the IR-reflective pigment, UV protection agent(s), photoinitiator and the UV light source which allow for an efficient curing of the UV cured urethane/acrylic coating. The coating components and the UV light source are selected in combination to allow for the transmission of a frequency of UV light from the emission source through the entire thickness of the coating.

An advantage of the product according to the present invention is that the final product is resistant to weathering. In preferred embodiments, the substrate, having been extruded, is then embossed with a woodgrain or other appealing pattern and then coated with a high performance cross-linked polyurethane/acrylic coating. The coating preferably contains UV protection agents, pigments having good IR reflectance and low solar temperature gain and additives that enhance scratch and mar resistance and provide an anti-slip surface. The color of the composite according to the present invention resists fading to a weathered grey color when exposed to rain water and sunlight. The substrate generally contains a similar coloration as the coating, but does not require the enhancement and thus is far less expensive.

An additional advantage of the method and product according to the present invention is that the final product maintains a lower surface temperature when exposed to sunlight, making the material desirable as an underfoot decking material.

An additional advantage of the method and product according to the present invention is that the materials for fabrication are comparatively inexpensive and provide an alternative to natural wood and/or composite materials present in the building materials marketplace.

An additional advantage of the method and product according to the present invention is that the composite material has a high tensile strength, flexural modulus and impact resistance, making the composite material resistant to chipping, flaking and/or breaking. In addition, the material has an increased stability underfoot, when used as a decking material.

An additional advantage of the method and product according to the present invention is that the composite material has a low water absorption rate. A lower absorption rate makes the composite lighter in weight and more uniform in expansion properties. Lighter weight and uniformity in expansion properties results in a product that is easier to install and does not produce gaps from non-uniform expansion and contraction. Also, the lack of water absorption prevents microbial growth.

An additional advantage of the method and product according to the present invention is that the composite material is resistant to insect and termite damage not only due to low moisture absorption but to the lack of nutrients in the composition. An additional advantage of the method and product according to the present invention is that the composite material is resistant to bacterial and fungal growth.

An additional advantage of the method and product according to the present invention is that the composite material is resistant to fire. In preferred embodiments using PVC as the matrix material, the resulting composite building material has a high ignition resistance and is self-extinguishing.

An additional advantage of the method and product according to the present invention is that the composite material has a similar look and texture as natural wood, making it suitable to replace existing wood or other composite building materials used in, for example, fencing, dock, decking, siding, and railing applications.

Other features and advantages of the present invention will be apparent from the following more detailed description of the preferred embodiment, taken in conjunction with the accompanying drawings which illustrate, by way of example, the principles of the invention.

### DESCRIPTION OF THE FIGURES

FIG. 1 shows a cutaway view of an extruded composite material 100 according to an embodiment of the present invention having a cellular structure formed of gaseous voids 110 having cell walls of polymer matrix 130 and reinforcing filler 120.

FIG. 2 shows a method of making the composite building material according to an embodiment of the present invention.

FIGS. 3A and 3B show a perspective view of a decking material according to an embodiment of the invention.

FIGS. 4A and 4B show the emission spectra of UV-emitting bulbs for use in the coating curing process.

Wherever possible, the same reference numbers will be used throughout the drawings to refer to the same or like parts.

### DETAILED DESCRIPTION OF THE INVENTION

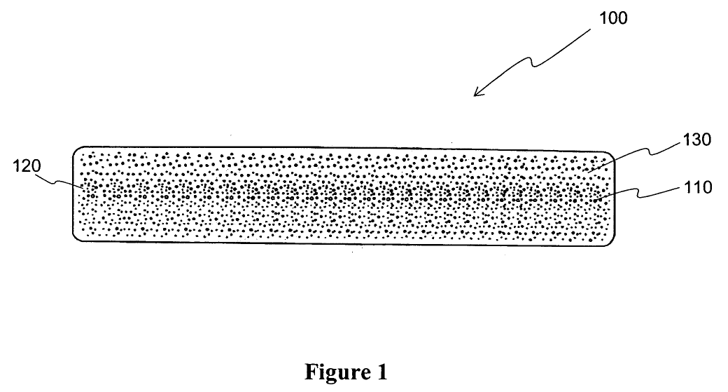

FIG. 1 shows a cutaway view of an extruded composite material 100 according to the present invention. The composite includes a cellular structure formed of gaseous voids 110 having cell walls of polymer matrix 130 and reinforcing filler 120. The reinforcing filler 120 preferably has a high surface area and is sized less than 1 micron particle diameter. The reinforcing filler at its high loading reduces the thermal expansion coefficient of the composite material 100. The gaseous voids 110 provide the composite material 100 with a lower density and compressive strength relief. The lower density provides a material that is easier to install and less expensive to transport. The compressive strength relief provides sufficient localized yield to permit screwing and/or nailing during installation without damage to the surrounding material. The gaseous voids 110 form the space around which the polymer matrix 130 and reinforcing filler 120 form the cellular structure. The material includes internal stresses resulting from the cellular structure and the filler reinforcement. The internal compression stresses provide the material with overall increased tensile strength and stiffness, while the gaseous voids 110 permit localized stress relief.

The composite of the present invention includes a desirable combination of properties useful for building materials. The desirable properties of the composite material include low density, high tensile strength, high flexural modulus, high impact strength, low water absorption, and good resistance to weathering. In particular, the composite material according to the present invention has a density of less than about 1.0 g/cc, preferably less than about 0.7 g/cc. The density may be measured by any suitable test known in the art, including ASTM standard D792. The composite material according to the present invention preferably has a strength (i.e., tensile strength) of greater than about 2600 psi., preferably greater than about 2800 psi. The tensile strength may be measured by any suitable test known in the art, including ASTM standard D638. The composite material according to the present invention also preferably has a flexural modulus of greater than about 400 kpsi., preferably greater than about 230 kpsi. The flexural modulus may be measured by any suitable test known in the art, including ASTM standard D790. The composite material according to the present invention also preferably has impact strength of greater than about 150 inch-lbs., preferably greater than about 160 inch-lbs. The impact strength may be measured by any suitable test known in the art, including ASTM standard D2794. The composite material according to the present invention preferably has water absorption rate of less than about 1%, preferably less than about 0.5%. The water absorption may be measured by any suitable test known in the art, including ASTM standard D570. The composite material and it's urethane acrylic coating according to the present invention preferably has weathering rate (i.e., color stability) of less than 3.0 delta E, preferably less than about 2.0 delta E. The color stability may be measured by any suitable test known in the art, including ASTM standard G-26, 12 Month Florida Exposure and/or 2500 hour artificial weathering using a UVA-340 lamp.

The mixture of ingredients for extrusion includes a polymeric matrix material. Suitable polymeric matrix materials may include, but are not limited to, poly (vinyl chloride) (PVC), chlorinated PVC, polyethylene, polypropylene, polystyrene, styreneacrylonitrile, acrylonitrile butadiene styrene, acrylic/styrene/acrylonitrile block terpolymer (ASA), polycarbonates, polyurethane, and co-polymers or combinations thereof. The composition may include one or more polymeric matrix materials.

In preferred embodiments the polymeric matrix material is PVC resin. The PVC resin preferably provides at least a portion of the matrix of the composite material. Any PVC resin suitable for forming a cellular structure may be used. The PVC resin is preferably a low average molecular weight material that provides an inherent viscosity of about 0.75 to about 0.83, preferably about 0.78 to about 0.8. Inherent viscosity may be measured by any suitable means known in the art, including viscosity measured by ASTM standard D1243. The process preferably uses a lower average molecular weight material in order to provide lower processing temperatures during extrusion. Because the process utilizes a lower processing temperature, the stabilization and long term weathering of the finished composite is increased.

When, as is preferred, PVC is the polymeric matrix material, a stabilizer may be used to inhibit the dehydrochlorination of the PVC and prevent burning of the PVC during the processing in the extruder. A stabilizer is a material added to the extrusion mixture to impart heat and light stability and/or lower the decomposition temperature of the blowing agent. Suitable stabilizers for use in the present invention include tin mercaptides. A suitable stabilizer includes, but is not limited to, a combination of tin mercaptide and di-butyl tin maleate, wherein a free maleic acid may also be present. Although a preferred stabilizer includes a combination of tin mercaptide and di-butyl tin maleate, any stabilizer that lowers the decomposition temperature of the blowing agent and/or provides free radicals for cross linking with the coating may be used. This provides for a fusion bonded surface to substrate adhesion. Suitable stabilizers are available from Rohm and Haas under the trade names TM-181, TM-182, TM-183C, TM-186, TM-281, TM 283, TM-286SP, TM-440, TM-599, TM-694, TM-697, TM-900, TM-950, TM-1830, S-1000, S-1201, and S-1401.

Lubricants preferably are added to the extrusion mixture for extrusion in order to provide internal lubrication within the polymer mixture and to provide external lubrication for metal release from the extruder during extrusion. The lubricant for internal lubrication is added to the extrusion blend in order to control fusion and allow slip between the polymer chains. The lubricant for external lubrication provides a wetting of the melt surface lubrication and easier release at the melt/metal interface at the surface of the extruder. The mixture may include one or a combination of lubricants that provide internal and external lubrication. Any material useful as internal and/or external lubricants may be used in the mixture for extrusion. Suitable lubricants for external lubrication include, but are not limited to, paraffin wax and oxidized polyethylene. Suitable lubricants for internal lubrication include, but are not limited to, carboxylic acid salts (e.g., calcium stearate).

The reinforcing filler(s) provides improved strength to the finished composite material 100 according to the present invention. The reinforcing filler preferably has a high surface area to weight that provides reinforcement to the polymer matrix. The reinforcing filler may be any type of organic, inorganic, or natural fiber or powder, or a mixture thereof, suitable for providing the desired structural qualities and durability. Examples of suitable fillers that may be used in the composition include calcium carbonate, talc, calcium sulfate (e.g., gypsum), magnesium oxide, diatomaceous earth, mica, glass fibers, silica, wollastonite and/or mineral wool. Although cellulosic materials may be used in certain embodiments of the present invention, they are generally not preferred. Examples of cellulosic fillers include wood powder, wood fiber, flax, or other natural fibers. In preferred embodiments, the filler is an inorganic, non-fibrous material such as calcium carbonate, calcium sulfate, talc, etc., and is most preferably calcium carbonate.

In a particularly preferred embodiment, when the reinforcing filler comprises an inorganic material, the surface of the reinforcing filler is treated with polar compatibilizer. Polar compatibilizers include material suitable to treat the surface of the reinforcing filler. Preferred compatibilizers include ionic surfactants, non-ionic surfactants, polyethene oxides, etc. Thus, in particularly preferred embodiments, reinforcing filler comprises a nanoparticle-sized calcium carbonate which is surface treated with a polar compatibilizer.

The mixture of ingredients for extrusion preferably includes a high loading of the reinforcing filler material(s). In the formulation according to the invention, the formulation may comprise 5-50 parts per hundred of the filler material(s), preferably 15-50 parts per hundred of the filler material(s), and more preferably 18-25 parts per hundred of the filler material(s). Preferably, the filler is selected to be a material that fills the matrix and has a low cost. Additionally, the filler may provide assistance in catalytic decomposition of the blowing agent. In order to provide greater cell nucleation in the matrix material, the filler material preferably has a high surface area—for example the filler may be ground to a fine particle size. Suitable particle sizes include, but are not limited from about 0.3 microns. Further it is preferred that the filler be of a high purity. Suitable purities include, but are not limited to, greater than about 99.5%.

Processing aids are preferably added to the mixture for extrusion in order to provide increased cell wall strength and good cell nucleation. The use of the processing aids allows the use of lubricant for external lubrication in order to prevent sticking to the extruder. Suitable materials for use as processing aids include a combination of a high molecular weight acrylic resin with a low molecular weight acrylic resin. The low molecular weight acrylic resin component primarily provides lubrication, while the high molecular weight acrylic resin provides some lubrication, but primarily assists in cell formation. The combination of processing aids provides a lubricated product that forms a desirable cellular structure, including high cell wall strength and good cell nucleation. High cell wall strength and good cell nucleation provides a finished composite having increased rigidity and increased weatherability. The increased weatherability is a result of the high molecular weight acrylic resin and is more light-stable than PVC resin alone. While the processing aids have been described as a combination of a high molecular weight acrylic resin and a low molecular weight acrylic resin, the processing aids added can be any processing aid or combination of processing aids that provide lubrication to the process, provide good cell formation and provide a light stable material. Suitable acrylic processing aids are commercially available under the trade names Paraloid K-415, Paraloid K-400, Paraloid K-175, Paraloid K-128N, Paraloid K-125, Paraloid K-120, Paraloid K-120N, Paraloid 120ND, and Paraloid K-130D from Rohm & Haas; and PA-20, PA-40, and PA-50 from Kaneka Corporation.

Titanium dioxide is preferably added to the mixture for extrusion in order to provide a background tint for the substrate pigments. The titanium dioxide helps to provide opacity to the coated finished composite.

A blowing agent is preferably added to the mixture for extrusion in order to provide porosity to the finished composite material. The blowing agent is preferably a combination of materials that include a carrier, a catalyst, an endothermic component and an exothermic component. The endothermic component and the exothermic component both contribute to the formation of the gaseous voids 110 and the cellular structure in the composite material 100. The blowing agent combination, including the carrier, catalyst, the endothermic component and the exothermic component, is ground to a fine particle size. Suitable particle sizes for blowing agent components include, but are not limited to, 1-5 micron diameter. The endothermic component may be added to the mixture during the extruding step. The carrier is any carrier that melts easily in the extruder and disperses the combination of blowing agent components throughout the mixture for extrusion. A suitable carrier for use in the blowing agent includes, but is not limited to, ethylene-vinyl-acetate copolymer. The catalyst is a material that assists in decomposition of the exothermic component. The catalyst is any material that assists in the decomposition of the exothermic component during heating. The endothermic component preferably creates an endothermic reaction when it thermally decomposes to provide temperature control of the system. When the endothermic component thermally decomposes, gases, such as carbon dioxide and/or water, are emitted and distributed throughout the extruded composite. The gases contribute to the formation of the cellular structure of the composite material 100. The endothermic component also provides alkalinity to the mixture, neutralizing undesirable acid components, such as HCl, which may contribute to degradation of the final composite material. A suitable endothermic component includes, but is not limited to, sodium bicarbonate. The exothermic component is a material that thermally decomposes in the extruder during the extrusion process and forms cells of gas within the finished composite. When the exothermic component decomposes, gases are dispersed into the resin matrix. The gas released by the exothermic component may be any gas that is capable of forming cells in the resin matrix and does not degrade the resin matrix. The gas released may include nitrogen or carbon dioxide. Suitable exothermic components include chemicals that contain decomposable groups such as azo, N-nitroso, carbonate, carbonamide, hetero-cyclic nitrogen containing surfonyl hydrazide groups. One suitable exothermic component includes, but is not limited to, azodicarbonamide.

Pigments which do not bleed and have appropriate light stability are preferably used to tint the substrate to a color relatively close to the coating. Pigments should disperse and flow well in the melt stream.

Table 1 includes formulations according to the present invention. PPH, as described in Table 1, are parts by weight per 100 parts by weight of PVC resin.

TABLE 1

| Material | Range (PPH) | Preferred Range (PPH) |
|---|---|---|
| PVC Resin | 100 | 100 |
| Stabilizer | 0.5-3 | 0.75-2 |
| Lubricants | 1-5 | 1-3 |
| Reinforcing Filler | 15-50 | 18-25 |
| Processing Aid | 1-25 | 5-20 |
| Titanium Dioxide | 0.5-20 | 0.5-10 |
| Blowing Agent | 0.5-20 | 0.5-10 |
| Substrate | 0-10 | 1-8 |
| Colorants | | |
| Zinc maleate | 0-5 | 0-1 |

Although the above has been shown as a preferred combination of ingredients, the mixture for extrusion may also include additional additives for improvement of physical or chemical properties.

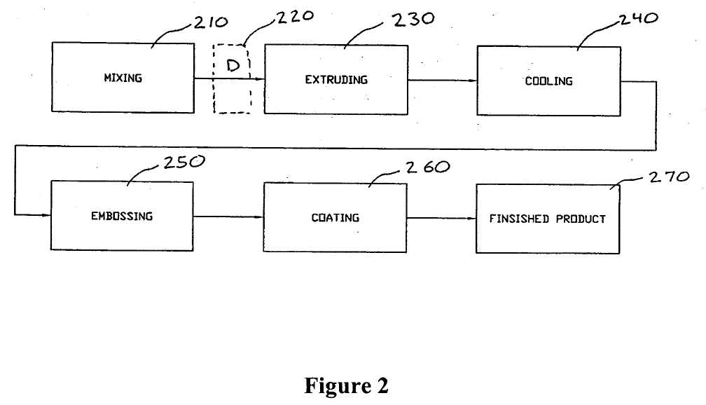

FIG. 2 shows a method according to the present invention. The method includes a mixing step 110, wherein the ingredients for extrusion are blended together. After the ingredients are blended, a devolatilization step 220 is performed. Devolatilization takes place by heating the mixture to a sufficient temperature to volatilize water and any impurity gases, such as organic vapors from the polymer, emitted from the mixture. The temperature of devolatilization is maintained below the fusion temperature of the mixture. Temperatures suitable for devolatilization include temperatures from about 200° F. to about 220° F. Because the temperature of the mixture is below the thermal decomposition temperature of the endothermic component and the exothermic component of the blowing agent, the blowing gasses are permitted to remain in the mixture for extrusion. The devolatization step 220 results in a removal of a significant amount of moisture remaining in the extrusion mixture. In one embodiment of the invention, the devolatilization takes place until the moisture of the mixture is reduced to below 1 wt % moisture, preferably wt ½ wt % moisture. Removal of moisture and volatile gases from the mixture provides a more uniform composition in the final product having fewer defects. After the mixture is devolatilized, the mixture is cooled and packaged for transport to the extruder. Although all of the ingredients may be mixed in the mixing step, one or more of the ingredients may be omitted from the mixing step 210 and may be added during extrusion. The mixture may include all new material, or may include recycled material. The inclusion of recycled material reduces the cost of the final product. The recycled material is preferably granulated and/or pulverized in order to obtain a particle size similar to the size of the new material.

Once the ingredients have been mixed and the mixture for extrusion has been packaged, the mixture is extruded in an extrusion step 240. Extrusion takes place by heating the extruder screws to a temperature sufficient to fuse and melt the matrix material. Temperatures suitable for extrusion include temperatures of about 340° F. to about 425° F. The extruder mixes the material as it is heated. Any additional ingredients not added during the mixing step 210 may be added to the extruder. Although all of the ingredients may be blended into the mixture during the mixing step 210, one or more of the ingredients may be added during processing directly into the extruder. For example, the blowing agent, the recycled material, the stabilizer, the pigments and/or other ingredients may be provided directly into the extruder to be mixed with the other ingredients. In one embodiment of the invention, the endothermic component of the blowing agent is added directly to the extruder during extrusion.

The endothermic component of the blowing agent thermally decomposes inside the extruder in an endothermic reaction. The endothermic reaction of the blowing agent catalyst reduces the heat resulting from the exothermic decomposition of the exothermic component of the blowing agent, providing temperature control to the decomposition reaction of the exothermic component. The mixture is sheared between screws inside the extruder and is heated to the temperature of fusion. The fusion of the powder mixture results in a melt, which is extruded through a die under pressure. Suitable temperatures for fusion for the mixture include temperatures from about 340° F. to about 425° F. The temperature of the screws is monitored to control the melt temperature. Excessive temperature rise causes a burning and/or destruction of the material. Insufficient temperature rise results in a lack of melting and large forces on the extruder. In addition to melt temperature, the temperature of the screw helps control the decomposition of the blowing agent. While the mixture is heated inside the extruder, the endothermic component and exothermic component of the blowing agent thermally decomposes, releasing a gas, such as nitrogen or carbon dioxide, throughout the melted matrix material (i.e., the melt). Simultaneously, the endothermic component of the blowing agent decomposes releasing gases, such as carbon dioxide and water vapor, which helps cool the exothermic reaction of the exothermic component. After the mixture is melted and substantially uniform, the melt is expelled from the extruder through a die. The mixture exits the die at a relatively high pressure and temperature. The material leaving the die is generally greater than about 350° F.

The die has a geometry that provides increasing compression as the material exits the extruder. The die includes an internal die mandrel that channels the melt and provides the desired geometry to the composite part. The internal die mandrel also provides the product with a wall thickness. The geometry of the die depends on the shape of the composite component design. The die may be any geometry that is suitable for extrusion. For example, for composite deck fascia materials, the die may be configured to provide a rectangular slab composite having a rectangular cross-section having one dimension of about ¼ inch and a second perpendicular dimension of about 8 inches. The length of the material may be any length and is only limited by the desired application and the capacity of the extruder and/or production facilities. The invention utilizes the application of a highly modified Celuka process. This process utilizes a die that extrudes through a slit having net shape dimension. Through control of die temperature a hard skin emerges from the die and all foaming occurs inward. Because of this, the physical properties of the product are substantially improved compared to the processes where foaming occurs outward and the outer surfaces are low density and soft.

At the completion of the extrusion step 230, the mixture exits the die. Once the material is through the die, the pressure exerted on the mixture is reduced to atmospheric pressure. The gases produced by the blowing agent expand under the reduced pressure and the matrix material solidifies, trapping the gas bubbles inside the composite material. The gas bubbles form voids in the composite. The voids form a closed cellular structure that provides desirable properties to the final product. As the resin matrix solidifies, the voids form a cellular structure made up of a plurality of cells. The cells are defined by cell walls formed from the resin matrix. The structure of the present invention produces a large number of cells having strong cell walls. The large number of cells and the high strength of the cell walls result in a finished composite having desirable mechanical properties. The void space within the cells provides the composite material with a lower density and compressive strength relief. The lower density provides a material that is easier to install and less expensive to transport. The compressive strength relief provides sufficient localized yield to permit screwing and/or nailing during installation without damage to the surrounding material. The cellular structure provides the composite with structural stiffness.

After the extruding step, the material is sized and cooled at a controlled rate in step 240. As the material exits the die, the material is fed to one or more calibrators. Calibrators are devices provided at or near the die exit that have at least one surface having a smooth texture, temperature control and means for holding the extrudate. The calibrators provide the finished product with desired geometry, while holding and providing controlled cooling of the material. The calibrators preferably use vacuum to hold the extrudate against the calibrator surface. As the material is extruded, the extrudate is slid across the calibrator providing the extrudate with the desired surface finish.

The calibrators also provide controlled cooling of the composite material. The material leaving the die is generally greater than about 350° F. The cooling rate is controlled in order to slow and/or halt the decomposition of the blowing agent at the surface. The slowing and/or halting of the decomposition at the surface provides desirable surface characteristics, including a substantially smooth continuous surface, while simultaneously allowing expansion across the thickness of the material. The composite material is permitted to expand in the direction extending from the calibrator surface. In one embodiment of the invention, the calibrators form a generally rectangular cross-section and each of the four edges of the rectangular cross-section includes a calibrator. In this embodiment, the edges form the surfaces and the expansion takes place inward toward the center of the cross-section of the material. Expansion, with respect to the size and controlled cool step 240 means expansion of the gaseous bubbles inside the composite material. The larger the area, the greater the amount of expansion. Because the calibrators cool the surface of the composite, the thermal decomposition of the blowing agent is slowed or stopped, the matrix is solidified and the surface is rendered smooth. Therefore, the surface contains few if any gaseous bubbles. However, the greater the distance from the calibrator, the greater the amount of expansion takes place and the greater the number and size of the gaseous bubbles. This process results in the composite material having a dense (i.e., substantially un-foamed) integral skin and a less dense, foamed (cellular) core. In one embodiment, the composite is a decking material, where the thickness of the composite material is relatively large; the calibrators are set farther apart, allowing a greater amount of expansion. In another embodiment, the composite is a deck fascia application, where the thickness of the material is relatively small; the calibrators are more closely together and reduce the amount of expansion of the material. Thicker materials have a greater number and a larger size of gaseous voids in the center of the material than thinner materials.

The calibrators are preferably provided with a temperature gradient to assist in gradual cooling of the material. In one embodiment of the invention, the calibrator closest to the die exit is set to from about 110° F. to about 140° F. The temperature of the surface of the calibrator is varied so that the temperature gradually decreases as the extrudate slides across the calibrator from the die exit. Once the composite material has cooled sufficiently to solidify the resin matrix, the composite is subject to a final cooling. The final cooling generally halts the residual decomposition of the blowing agent and/or expansion within the material. The final cooling may take place using any cooling method known in the art, including spraying or immersing the composite with water, preferably chilled.

Once the composite material has been cooled, the material is then, optionally, reheated on the surface to about 220 degrees using infra red heat. The heated product then passes through a two-roll hydraulic embosser having either one or two engraved rolls which deboss an aestethetically pleasing image onto the surface. The surface temperature is tightly controlled to provide the necessary plasticity to deform the surface and to prevent rebound under use temperature. The thickness of the deformed portion of the composite material includes thickness from about 1.5 thousandths of an inch to about 50 thousandths of an inch.

Following optional embossing, the finished product is preferably coated with a thin urethane/acrylic coating. Preferably the coating has a thickness of about 0.5 to about 3.0 thousandths of an inch. In many embodiments, conventional spray guns may be used to apply the coating. When the composite building material is a deck product, it may be coated on the embossed surface and the adjacent sides. The embossed (top) surface may have a thicker coating layer, for example about 1.0 to about 3.0 thousandths of an inch, and preferably about 2.0 to about 2.5 thousandths of an inch, than the coating thickness on the sides, which may be about 1.0 thousandths of an inch thick.

In some embodiments of the invention, a suitable urethane/acrylic coating is a commercial product produced by Valspar under the trade name of Valthane. Another suitable coating is Polane produced by Sherwin Williams. The polymeric backbones of these products are the same (urethane/acrylic) and the free radical generation as well as catalysis is similar.

In particularly preferred embodiments, the urethane/acrylic coating is physically and/or chemically “keyed’” or bound, to the surface of the substrate. The term keyed as used herein refers to a process by which the adhesion of the coating to the substrate is improved. This may be accomplished by the selection of a suitable solvent for the application of the coating which dissolves a thin layer of the substrate. When the solvent is removed, a thin interlayer comprised of comingled substrate material and coating material may be formed. Additionally or alternatively, heat generated during the curing of the applied coating may facilitate the formation such a thin interlayer of commingled substrate material and coating material. Additionally or alternatively, the adhesion of the coating to the substrate may be accomplished by the addition of a chemical agent to the substrate that can cross-link with the coating material. Suitable materials that can be added to the substrate for cross-linking to the coating include substance comprising a maleic group, or other chemical moiety that may react by a free radicals mechanism for cross linking with a component in the coating. In other embodiments, the substrate may be pre-treated prior to the application of the coating. Such pre-treatment includes pre-heating the surfaces of the substrate to be coated prior to the application of the coating. The surface of the substrate may be heated to a temperature above the glass transition temperature for the matrix polymer. Additionally or alternatively, the surfaces of the substrate to be coated may be pre-treated with a solvent. In certain preferred embodiments, the coating is both chemically and physically keyed to the surface of the substrate.

In one embodiment, the urethane/acrylic coating is applied using suitable solvents. For this embodiment, an important part of this process involves the selection of the solvents and diluents used in the coatings. Some solvation of the substrate surface is preferred for improved adhesion of the coating to the substrate. Particularly, solvents in the ketone family functions well as diluents for the coating, and as solvents for the vinyl surface. Preferred solvents include, but are not limited to, methyl ethyl ketone, methyl isobutyl ketone, methyl amyl ketone and the like, and mixtures thereof. Upon evaporation of the solvent the coating intimately impregnated into the surface of the substrate. The solvent may be evaporated in part under ambient conditions, typically followed by exposure to elevated temperatures.

The coating is cured and the solvent is evaporated under elevated temperatures, for example by using an oven. The oven preferably is maintained at a temperature of about 160° F. to about 180° F. In addition to evaporating any remaining solvent, the elevated temperature may activate the free radical catalyst for curing the coating.

In another embodiment of the invention, the urethane/acrylic coating may be coated onto the substrate and cured using an ultraviolet radiation (UV) curing system. This embodiment has the advantage that the use of volatile organic solvents may be minimized or eliminated. Thus, this embodiment has the advantages of being environmentally friendly and of reducing or eliminating the cost of solvent recovery. One or more of the reactive monomers provide the solvent-like properties and an appropriate viscosity for spray application of the coating.

In particularly preferred UV cured urethane/acrylic coatings, the coatings are based upon the use of difunctional aliphatic urethane oligomers. The reacted oligomer(s) constitutes a backbone of the coating an has the following general structure:

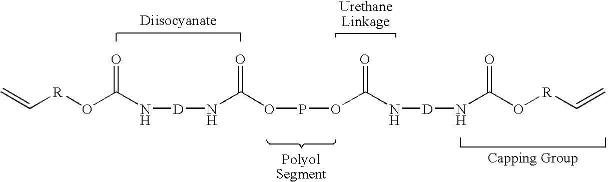

Preferred coatings may comprise a mixture of oligomers and monomers including alkoxylated acrylic monomer, acrylate monomer, highly functional monomer, and aliphatic urethane acrylate, which are commercially available for example from Sartomer. Other commercially available coatings may be appropriate for use in the present invention, such as Laromer UA 9048 (solvent-free urethane acrylate thinned with DPGDA). To adjust the processing viscosity of the urethane diacrylate oligomer, it can be mixed with other acrylic resins as well as monomers such as dipropyleneglycol diacrylate (DPGDA), tripropylene glycol diacrylate (TPGDA) and the like, or mixtures thereof. These monomers may also be used as solvents for the other coating components.

The UV curing of the coating is initiated by a photoinitiator that absorbs distinct energies of UV light, typically between 200-450 nm, and generates free radicals, which in turn initiate polymerization. When using a UV curing system, the selection of pigments and other coating additives may be performed to ensure that the pigment and other additives do not strongly absorb UV radiation at the same energy as the photoinitiator, such that action of the photoinitiator is impaired. When using the UV-cured coating, free radicals must be generated by specific wavelengths of ultraviolet energy acting on a free radical initiator dispersed within the coating. Since the preferred coating composition contains many interfering fillers, pigments and other additives, both the type of initiator as well as its response to UV light becomes an important part of the system. UV radiation of the proper frequency must reach the interface between the substrate and coating in order to obtain a complete curing of the coating and to promote adequate adhesion of the coating to the substrate.

The photoinitiator may be any appropriate material that generates free radicals upon exposure to UV light, and includes, for example, benzylic ketones and derivatives thereof, and preferably are benzophenones and derivatives thereof. Other preferred properties of the photoinitiator are that it be liquid borne with no VOC generation and that it not detract from long term weathering of the product. Appropriate photoinitiators include Esacure photoinitiators (for example, Esacure KTO 46), available from Lamberti and Lucirin TPO available from BASF. Also, bisaryl phosphine oxide (BAPO) type photoinitiators which are activated by longer wavelength UV light in the near visible region above about 430 nm may be appropriate. BAPO type photoinitiators are commercially available such as Irgacure 819, Irgacure 1800, Irgacure 1850, and the like. Preferably the photoinitiator is present in the coating material at an amount of from about 0.5 to about 10% by weight. In certain embodiments, a synergist may be added to the coating that facilitates the free radical generation of the photoinitiator. Synergists may include tertiary amines, acylated tertiary amines and alkoxylated acrylate monomers. In some cases, unactivated photoiniator may act as a UV absorber for the applied coating which enhances weathering.

The preferred coating compositions of the present invention have a break (or “window”) in absorption/reflectance at wavelengths between 380 and 450 nm. This transmission window allows for the UV light within that wavelength to penetrate the coating and initiate the curing reaction. The exact position of this “window” may be adjusted with changes in pigments and other additives will influence the upper or lower bounds of the transmission window. In formulating the coatings that contain the oligomers, pigments, and other additives (UV-protectant, gloss reducers, scratch and mar additives) requires attention to the desired transmission window. To this end, use of spectrophotometric measurements of the entire coating system may be useful.

In preferred embodiments, the photoinitiator is selected which has a peak response to UV light in the transmission window of the coating and the UV source emits strongly in the same region of the UV spectrum. Thus, in preferred embodiments, the source of the UV light emits strongly in the region of about 380 nm to about 450 nm. This is also the preferred region of the UV spectrum to which the photoinitiator is sensitive. The photoinitiator is distributed uniformly through the coating, therefore the UV light photons must get through the coating mixture to the photoinitiator molecules located at the adhesion interface between the substrate and coating.

The UV lamp(s) consists of a quartz tube typically containing a small quantity of mercury. The preferred bulbs used in this invention are powered by microwave. The microwave energy vaporizes the mercury and when the bulb reaches operating temperature the vapor becomes plasma and emits characteristic wavelengths of UV light as well as some visible light. These lamps generate a tremendous number of photons which are needed for penetration of the UV light to the bonding interface.

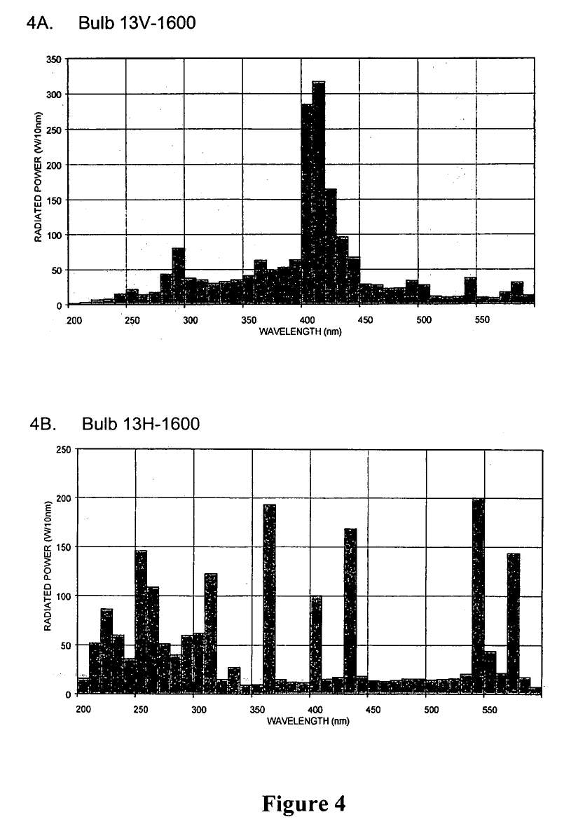

The emission spectra two type UV bulbs are provided in FIGS. 4A and 4B. The H bulb (4A) uses conventional undoped mercury and although there is a “spike” of energy between 400 and 450 nm, most of the power is of lower (shortwave) which is heavily absorbed by the coating components and cannot be used by itself for curing. This bulb is may be used for surface cure when used at a lower power level (fewer bulbs). Using this bulb does provide excellent development of surface cure through use of the intense 400-450 nm “spike.” The use of doping in the mercury bulb allows the plasma to emit concentrated wavelengths in the desired transmission region. The “V” bulb (4B) is doped with gallium and shows a strong emission in the region of 400-450 nm. Both of the bulbs used have a high radiated power, which is needed. Suitable UV bulbs are commercially available, for example from Fusion UV Systems, including bulb13V-I600 and bulb13H-I600.

The number of bulbs and type of bulbs are manipulated for the rate of coating as well as limiting heat generation. Also significant is the effective irradiance or UV radiation reaching the coated product. Rate, distance and reflectors alter the irradiance and are manipulated for peak performance.

Since plasma often reaches 20,000 degrees F., the quartz tube of the UV bulbs heats and radiates infra red energy. It is important that the heat not reach the substrate and cause surface decomposition as most plastics will degrade quickly under high energy IR (heat) buildup. Thus, it may be important to limit the infra red emission through the use of heat absorbing reflectors and air cooled bulbs. Without the use of these elements, the generated heat may burn the substrate. The use of a chilled grid between the coated substrate and the lamp may also be needed at lower coating rates. The use of infrared reflective pigments that reflect substantial amounts of infra red energy may assists the coated substrate to withstand heat generated by the UV lamp.

In preferred embodiments, the UV-curable urethane/acrylic coating is applied to provide a coating thickness ranging from about 0.0005 to 0.003 inches. This range of film thickness generally provides optimum performance and provides the opportunity to use very intense ultraviolet light to penetrate the coating and provide enough energy at the substrate to cure the coating at the interface between the coating and substrate. This also promotes adhesion of the coating to the substrate. Multiple coats having this thickness may be applied, with curing between each coat.

The use of a UV coating system has the further advantage of reducing manufacturing space and increasing productivity. Typical cure times may be less than a second, allowing for higher line speeds. Thus, the use of a UV curing system is well suited for use in a process in which the substrate is coated with the urethane/acrylic coating as part of the same process for making the substrate. For example, the substrate may be coated immediately following embossing, followed by a radiation curing step. As the use of solvents may be minimized in this embodiment, the inclusion of one or more chemical agents in the substrate, coating or both that facilitate cross-linking of the substrate with the coating is particularly preferred. In certain embodiments, the surface of the substrate may be treated in a manner to facilitate physical keying of the coating to the substrate the surface prior, or concurrently with, the coating and radiation curing. For example, the surface of the substrate may be pre-heated or pre-treated with a solvent.

The coating is preferably enhanced with pigments selected to provide exterior weathering and low solar heat gain. In certain embodiments, UV absorbers are added that greatly enhance ultraviolet light stability. Particulate alumina deglossing agents are added to control surface gloss while enhancing scratch and mar resistance. The alumina may be added in an amount of about 1% to about 4% by weight. Specifically, alumina nanoparticle additives are commercially available from Byk Chemie as the Nanobyk additives, including Nanobyk-3602, Nanobyk-3610 and Nanobyk 3650.

Preferred pigments for use in the coating have a low solar gain. Such pigments reflect rather than absorb infrared light. This results in a relative cooling effect as compared to other pigments. The lower solar heating of the material has many potential benefits, such as less expansion and contraction, less product degradation and improved comfort levels for materials that may contact the skin (for example, decking materials underfoot). The pigment(s) may be present in the coating in an amount of about 10% to about 20% by weight. Suitable pigments typically are fine ground mixed metal oxides and are commercially available, for example Ferro Corporation's Geode Cool Colors and Eclipse pigments.

When the pigment is used in a coating that is to be cured using a UV curing system, it is preferably selected to allow sufficient transmission of the required frequencies of UV radiation for activation of the free radical initiator throughout the depth of the coating. Thus, particularly preferred pigments for use in the present coatings have both a low solar gain (high IR reflectivity) and are substantially transparent to UV radiation in the near or mid UV spectrum. More specifically, the pigment should be substantially transparent to the frequency of UV light that is used to activate the photoinitiator. Suitable pigments are commercially available, for example Ferro Corporation's Cool Colors and Eclipse pigments, and particularly colors 10364 (brown), V-9416 (yellow), V-13810 (red), and the like.

The pigments may be dispersed in the coating composition using high energy liquid dispersators such as Cowles or Hockmeyer mixers. In preferred embodiments, the pigments are dispersed in a reactive urethane/acrylic precursor oligomer and are supplied in liquid form, preferably as a concentrate for later addition to the coating composition. This limits VOC's, which is environmentally important. It is often useful to use small additions of dispersing aid and suspension aids in preparing the dispersion of the pigments in the oligomer or coating composition.

Composite building materials produced using this invention include, but are not limited to, siding, decking, railing, fascia, roof shingles, floor tiles, paneling, door and window trim, outdoor furniture, fencing, playground equipment, and/or docks.

The shape of the composite material of the present invention is not limited to a rectangular cross section. The composite material may be any geometry that can be extruded, sized and cooled according to the method of the present invention. The shapes may include complex shapes, such as ornamental pieces, railings, fencing or accessories for siding and/or decking.

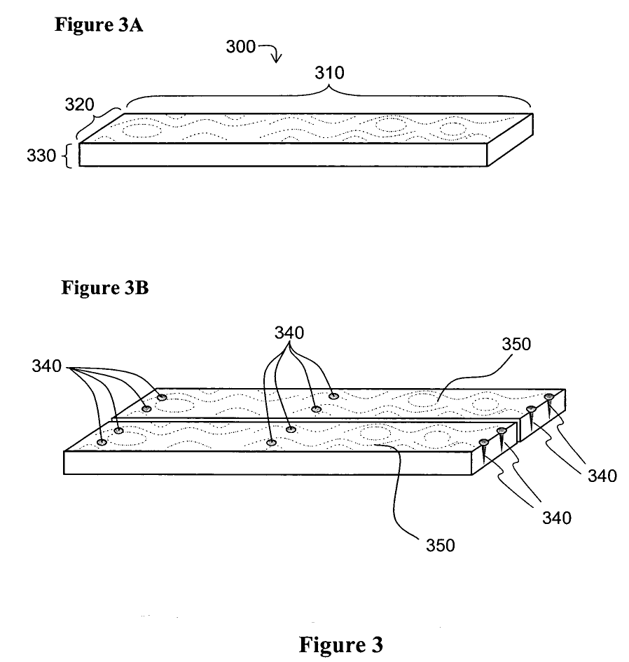

FIGS. 3A and 3B show a perspective view of a decking material according to an embodiment of the invention. By decking material it is meant that the material is suitable for use in fabrication of a deck or a dock, including ornamental pieces, railing, fencing and/or the surfaces that are exposed to outdoor conditions and receive pedestrian traffic. FIG. 3A shows a rectangular slab useful as a decking material. The rectangular slab includes a first dimension 310, a second dimension 320 and a third dimension 330. The first dimension 310 is defined by the length extruded. The first dimension 310 is only limited by the capacity of the extruder. In decking applications the first dimension 310 would be defined by the desired length horizontally along the area to receive the decking material. Examples of lengths for the first dimension 310 include about 12, 16 or 20 feet. The second dimension 320 is a dimension forming the width of the cross-section of the extrusion. The second dimension 320 for use in decking application may include any suitable width for decking applications, including desired plank width for structural support and/or pleasing aesthetics. Examples of widths for the second dimension 320 include about 4, 6, 8 or 12 inches. The third dimension 330 is a dimension forming the thickness of the cross-section of the extrusion. The third dimension 330 for use in deck fascia application may include any suitable thickness for fascia applications. The third dimension 330 is preferably a thickness that produces a material that is lightweight, using less material, while maintaining resistance to outdoor conditions and providing sufficient structural support to maintain usefulness as a decking surface. Examples of thickness for the third dimension 330 include about 1, 1½or 2 inch width. The rectangular slab shown in FIG. 3A includes a hard, durable surface 350 that has been surface cured. Although FIG. 3A shows the surface to be defined by the first dimension 310 and second dimension 320, any or all of the surfaces may be subject to the surface curing step 250 to form a hard, durable coating. FIG. 3B illustrates the application of the rectangular slab in a decking application, particularly in the flooring portion of a deck. During installation, the rectangular slabs are positioned adjacent to each other with the hard, durable surface 350 exposed on the surface subject to the outdoor conditions and/or pedestrian traffic. Once positioned, nails or screws 340 are driven through the composite material into the decking supports (not shown). The spacing between the nails or screws 340 may be any spacing desired by the installer or required by local code.

An additional advantage of the method and product according to the present invention is that the composite material is resistant to fire. In preferred embodiments using PVC as the matrix material and calcium carbonate as the reinforcing filler, the resulting composite building material has a high ignition resistance and is self-extinguishing. In preferred embodiments the composite building material has a Flame Spread Index (FSI) less than about 50, and preferably less than about 25. The FSI is measured according to the procedures outlined in ASTM E 84-06.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

### EXAMPLES

### Example 1

A deck board according to the present invention was prepared having the composition set forth in Table 2.

TABLE 2
Substrate Composition

| Material | PPH |
|---|---|
| PVC Resin | 100 |
| (FPC 616) | |
| Stabilizer | 0.8 |
| (TM-181) | |
| Lubricant | 0.8 |
| (Paraffin 165) | |
| Lubricant | 0.15 |
| (PE AC 629A) | |
| Lubricant | 0.6 |
| (calcium strearate) | |
| Reinforcing Filler | 18 |
| (calcium carbonate, 0.7 | |
| micron treated UFT) | |
| Processing Aid | 6.0 |
| (K-400) | |
| Processing Aid | 1.5 |
| (K-175) | |
| Titanium Dioxide | 0.5 |
| Blowing Agent | 0.8 |
| (Forte-Cell 247 Azo) | |

The ingredients from Table 2 are loaded into its on-line feeders which is calibrated for each individual material dose rate. The raw material feeder systems used to make may be volumetric or gravimetric, or combinations of each. These feeder systems deliver the pre-calibrated volume or weight of each material to a central neck piece which is attached to the feed port of the extruder. Materials are delivered in a “Starve feed” mode which allows the extruder screws to be covered approximately 90% of total depth.

The raw materials described in the preceding paragraph are mixed in an extruder. The extruder is a counter-rotating, profile twin screws (either conical or parallel screws). The extruder melt-mixes, or flux's, the compound ingredients using shear, heat, and pressure to form a homogeneous molten mass containing an evenly distributed mixture of the raw materials. Melt temperature is the extruder is of 350-360 degree with a pressure of about 1200-3000 psi. The extrusion is performed at a rate about 300 pounds per hour (conical) or about 1200 pounds per hour (dual-strand). The extrusion process prepares the compound to be shaped into the deck form that becomes our final product.

The next part of or process is the exit of the molten or fluxed compound from the extruder into the die. The process uses a Celuka die design, which enables the foamed vinyl compound to yield a deck board that is dense at the surface with an integral skin on all sides. The product density gradient goes from a high density surface to a lower density (foamed) core. The Celuka die is attached to the end of the extruder and receives the molten or fluxed compound. The die, is a high inventory, advancing compression streamlined Celuka die, which is configured using a series of sequential plates and mandrels. The die forms the initial shape of the deck board.

The next process phase is the calibration phase. The calibration step involves receiving the still hot formed deck shape from the die and finishing the formation of the deck board. A small lead-in plate at 55° F. is employed to presize the extruded deck board. The extruded board then passes through a train of 6-1′ foot long dry-sleeve calibrators that contain water and vacuum slots. The calibrator train helps form the tough integral skin and through the use of water and vacuum form and stabilize the final detailed shape of the deck board.

After calibration the deck board enters a series of cooling tanks equipped with chilled water spray systems. This chilled water spray is applied to the deck board on all sides and continues the cooling process of the deck board. This section of the process can be long, sometimes exceeding 50 to 60 feet. The spray tanks are typically operated under vacuum to help maintain the calibration shaped deck board. The spray tanks are typically equipped with rollers or templates that continue to hold the deck shape as cooling progresses.

Next, the deck board exits the vacuum cooling tanks and is put through an embosser that embosses the grain pattern into the surface of the board. To accomplish the, embossing the deck board is surface heated using an IR light sources to prepare the deck board surface to receive the embossing pattern. The surface temp is about 220° F. on the embossing surface, with a compensating heat on the opposite surface to avoid warping. The hydraulic embosser rolls are heated, with the top roll at about 350-400° F. and the bottom roll at about 250-300° F., and applies a pressure of 800-1200 pli.

The deck board is allowed to cool slightly before being cut to length. Usually these lengths are 12′, 16′, and 20′ long. The saw is part of the puller system which carefully controls the speed of the board as it enters the calibration stage until it is cut to length.

The coating process involves the use of a liquid spray applied coating. This process takes the uncoated but embossed boards and applies an acrylic-urethane based solvent spray coating containing all the necessary ingredients needed to provide a durable weather fast finish to the deck board. The uncoated deck board is preheated using an IR heat source to about 180-200° F. The acrylic-urethane coating is applied so that the final dry coating has a thickness of between about 0.0020 inch to about 0.0025 inch on the top (embossed) surface and a thickness of about 0.0010 inch on the sides. The deck board is coated at a rate of 80 to 100 feet per minute. After coating the deck board passes through an open area of 50-60 feet followed by a one hundred foot convection oven at about 180° F. (to maintain a board temperature below 160° F.).

The FSI, measured according to the procedures outlined in ASTM E 84-06, for the resulting composite decking material was 20.

### Example 2

A deck board having the same substrate composition as in example 1 was prepared and used in the UV coating process.

The UV-curable urethane/acrylic coating used to coat the board has the composition set forth below:

| Material | Weight % |
|---|---|
| urethane acrylic: | 90.7% |
| 10% Alkoxylated Acrylic Monomer | |
| 10% Acrylate Monomer | |
| 5% Highly Functional Monomer | |
| 38.5% Aliphatic Urethane Acrylate | |
| Esacure KTO46 photoinitiator | 3% |
| 30% Ferro Geode Pigments in PMDA | 10-20% |
| | (based on solids) |
| Nano Byk 3601 40 nm aluminum oxide in | 3.6% |
| TPGDA | |
| Acematt TS100 | 1.4% |

The urethane/acrylic monomer/oligomer composition is transferred to an appropriate vessel. The photo initiator is in liquid form and is mechanically stirred into the batch. Once the photoinitiator is added, the material must be kept away from any UV light sources and the material will have at least a two year shelf life when drummed and sealed.

The pigments (Ferro Geode) are dispersed in a reactive Sartomer oligomer (PDMA) and are supplied in liquid form. The Pigment concentrate dispersion is mixed in with the other components in stainless steel vessels using a propeller mixer at low speed so as to avoid air entrapment. Small additions of surfactant defoamers are used.

The Nano Byk 3601 40 nm aluminum oxide in TPGDA is added to the coating mixture. This ingredient is a liquid which is an oligomer reactant and is mixed using mild propeller action. The Silica is mixed into the coating mixture as above.

The deck board is transported through the process equipment by belt or roller conveyors. The deck board is cleaned at a rotary brush station where the brushes are nylon or abrasive impregnated nylon filaments. The coating is applied in a spray chamber where automatic paint guns apply the coating to the product surface at a thickness of 1 mil. The coating is delivered to the spray gun by a circulating system. Air for atomizing the coating is also supplied. To maximize coating efficiency, overspray is captured in drip pans and filter banks.

The coating is cured in a UV oven which is configured with Fusion “V” and “H” bulbs. Heat from the enclosed oven is removed by an exhaust system. To apply coating at a thickness greater than 1 mil the product is processed through the process line a second time (decking) or an additional spray chamber and UV oven added to the described configuration.

1. A composite building material comprising:
a foamed substrate having a foamed inner core and a dense integral skin, wherein the foamed substrate comprises a polymer matrix and a reinforcing filler; and
a urethane/acrylic coating applied to at least one surface of the foamed substrate, wherein the coating comprises an IR-reflective pigment;
and wherein the urethane/acrylic coating is chemically and/or physically bound to the substrate.

2. The composite building material of claim 1, wherein the polymer matrix is PVC.

3. The composite building material of claim 1, wherein the reinforcing filler is a non-celulosic material.

4. The composite building material of claim 3, wherein the reinforcing filler comprises calcium carbonate.

5. The composite building material of claim 4, wherein the reinforcing filler is present in the foamed composite in an amount of about 15 to about 50 parts per hundred relative to the PVC.

6. The composite building material of claim 5, wherein the reinforcing filler is present in the foamed composite in an amount of about 18 to about 25 parts per hundred relative to the PVC.

7. The composite building material of claim 1, wherein the urethane/acrylic coating further comprises aluminum oxide.

8. The composite building material of claim 7, wherein the aluminum oxide is present in the coating in an amount of about 1% to about 4% by weight.

9. The composite building material of claim 1, wherein the IR-reflective pigment is an IR-reflective mixed metal oxide.

10. The composite building material of claim 9, wherein the IR-reflective pigment is present in the coating in an amount of about 10% to about 20% by weight.

11. A process for the manufacture of a coated, foamed building material comprising the steps:
providing an extrusion mixture comprising a polymer matrix material, a reinforcing filler and a blowing agent;
heating the extrusion mixture to a melt temperature in an extruder under elevated pressure;
extruding the extrusion mixture through a Celuka die;
foaming the extrusion mixture;
shaping the extruded, foamed material to provide a composite foamed substrate;
coating the composite foamed substrate with a urethane/acrylic coating; and
curing the urethane/acrylic coating.

12. The process of claim 11, wherein the polymer matrix is PVC.

13. The process of claim 11, wherein the reinforcing filler is a non-celulosic material.

14. The process of claim 13, wherein the reinforcing filler comprises calcium carbonate.

15. The process of claim 14, wherein the reinforcing filler is present in the foamed composite in an amount of about 15 to about 50 parts per hundred relative to the PVC.

16. The process of claim 15, wherein the reinforcing filler is present in the foamed composite in an amount of about 18 to about 25 parts per hundred relative to the PVC.

17. The process of claim 11, wherein the extrusion mixture comprises 100 PPH PVC resin, 0.5-3 PPH of stabilizer, 1-5 PPH of lubricant, 1-25 PPH processing aid, 15-50 PPH reinforcing filler, and 0.5-20 PPH blowing agent.

18. The process of claim 11, wherein the extrusion mixture comprises 100 PPH PVC resin, 0.75-2 PPH of stabilizer, 1-3 PPH of lubricant, 5-20 PPH processing aid, 18-25 PPH reinforcing filler, 0.5-10 PPH blowing agent, 0.5-10 PPH titanium dioxide, and 1-8 PPH colorant.

19. The process of claim 11, wherein the urethane/acrylic coating comprises an IR-reflective pigment.

20. The process of claim 19, wherein the IR-reflective pigment is an IR-reflective mixed metal oxide.

21. The process of claim 20, wherein the IR-reflective pigment is present in the coating in an amount of about 10% to about 20% by weight.

22. The process of claim 11, wherein the urethane/acrylic coating comprises a photoinitiator and the curing is performed by exposure to an ultraviolet radiation light source.

23. The process of claim 22, wherein the urethane/acrylic coating further comprises an IR-reflective pigment.

24. The process of claim 22, wherein the urethane/acrylic coating further comprises aluminum oxide.
